(19) United States
(12) Patent Application Publication
(10) Pub. No.: US 2026/0283388 A1
(43) Pub. Date: Sep. 24, 2026

(54) TABLEWARE INCORPORATING SENSORS AND COORDINATED LED-GRAPHIC DISPLAY AND RESPONSE SYSTEM

(71) Applicant: Yumlit LLC, Glencoe, IL (US)

(72) Inventor: Seth Coan, Glencoe, IL (US)

(73) Assignee: Yumlit LLC, Glencoe, IL (US)

(21) Appl. No.: 19/572,832

(22) Filed: Mar. 19, 2026

Related U.S. Application Data
(60) Provisional application No. 63/774,159, filed on Mar. 19, 2025.
(60) Provisional application No. 63/885,874, filed on Sep. 22, 2025.

(51) Int. Cl. A47G 19/02; A47G 19/22; G01D 5/24; G01J 1/42

(52) U.S. Cl. CPC A47G 19/025; A47G 19/2227; G01D 5/24; G01J 1/4204; A47G 2019/2238; A47G 2019/2244

(57) ABSTRACT

An item of tableware is disclosed that may provide visual or auditory feedback in response to and/or as a result of the removal or consumption of food or liquid from the tableware. The tableware, for example, may include a plate, cup, mug, dish, bowl, etc. Visual feedback, for example, may be produced by one or more light emitting diodes. The feedback, for example, may enhance the eating experience of a child.

### BACKGROUND

Parents often struggle with getting their children to eat all of the contents on their plate or dish or drink the contents of their receptacle or cups.

### SUMMARY

An item of tableware is disclosed that may provide visual or auditory feedback in response to and/or as a result of the removal or consumption of food or liquid from the tableware. The tableware, for example, may include a plate, cup, mug, dish, bowl, etc. Visual feedback, for example, may be produced by one or more light emitting diodes. The feedback, for example, may enhance the eating experience of a child.

In some embodiments, a plate may include a central flat portion and a rim surrounding the central flat portion. The plate may include a first photosensor disposed within the central flat portion that produces a first signal representative of ambient light incident on the first photosensor. The plate may include a second photosensor disposed within the rim that produces a second signal representative of ambient light incident on the second photosensor. The plate may include a light emitting diode disposed within the central flat portion, wherein the light emitting diode may be activated when the difference between the first signal and the second signal is below a threshold, and the light emitting diode may be deactivated when the difference between the first signal and the second signal is above the threshold.

In some embodiments, the plate may further include a translucent or partially translucent graphic disposed within the central flat portion and a light disposed below the translucent or partially translucent graphic that illuminates the translucent or partially translucent graphic. The plate may include a controller electrically coupled with the first photosensor, the second photosensor, and the light emitting diode. The controller may be configured to determine the difference between the first signal and the second signal and to activate and deactivate the light emitting diode. The first photosensor may include a photoresistor and the second photosensor may include a photoresistor.

In some embodiments, the light emitting diode may include a plurality of light emitting diodes, wherein when the plurality of light emitting diodes are activated, the plurality of light emitting diodes may produce a pre-programmed sequence of colors and patterns. The plate may further include a battery electrically coupled with the light emitting diode, an indentation on a bottom surface of the plate, and a touch sensor disposed within the indentation and configured to open or close a circuit between the battery and the light emitting diode.

In some embodiments, tableware that provides sensory feedback may include a tableware body having a surface for holding consumable contents. The tableware may include a plurality of sensors integrated within the receptacle body that detect the presence and absence of the consumable contents on at least a portion of the tableware body. The tableware may include at least one sensory output device embedded within the tableware body that produces a sensory output. The tableware may include a microcontroller disposed within the tableware body and communicatively coupled to the plurality of sensors and the at least one sensory output device. The microcontroller may be configured to detect a state change in the plurality of sensors corresponding to the progressive or complete removal of consumable contents from the surface of the tableware body, and in response to detecting the state change, activate the at least one sensory output device to produce the sensory output.

In some embodiments, the plurality of sensors may include a plurality of photo resistive sensors and the state change may be a change in the light detected by the plurality of photo resistive sensors in response to the progressive or complete removal of consumable contents. The plurality of sensors may include a plurality of capacitive sensors and the state change may be a change in the capacitance detected by at least one of the plurality of capacitive sensors in response to the progressive or complete removal of consumable contents. The output device may include one or more light emitting diodes. The output device may include a speaker. The state change may be a difference measured by the microcontroller between two sensors of the at least one sensory output device, wherein the first sensor of the two sensors may be disposed in a central portion of the tableware body and the second sensor may be disposed in an outer rim of the tableware body.

In some embodiments, a method may include detecting, via a plurality of sensors embedded in tableware, an initial state corresponding to the presence of food on the tableware. The method may include continuously monitoring the plurality of sensors for a state change indicating the progressive removal of food from the tableware. The method may include, upon detecting the state change, activating an output device integrated within the tableware to generate a sensory stimulus perceptible to a user. The sensory stimulus may include emitting light. The method may further include illuminating a light within the tableware from a light source disposed below a translucent or partially translucent graphic. The state change may be a difference measured by a microcontroller between two sensors of the plurality of sensors. The plurality of sensors may include a plurality of photosensors.

The various examples described in the summary and this document are provided not to limit or define the disclosure or the scope of the claims.

### BRIEF DESCRIPTION OF THE FIGURES

FIG. 1 is a top view illustration of a plate.

FIG. 2 is a side view illustration a plate.

FIG. 3 is a perspective view illustration of a plate.

FIG. 4 is a cutaway perspective view illustration a plate.

FIG. 5 is a closeup cutaway perspective illustration of a plate.

FIG. 6 is a bottom view illustration of the bottom of a plate.

FIG. 7 is a perspective view illustration a bottom portion of a plate.

FIG. 8 is a perspective view illustration of a plate.

FIG. 9 is a side view illustration of a cup.

FIG. 10 is a flow chart of a process for illuminating tableware.

### DETAILED DESCRIPTION

Systems and/or methods are disclosed for tableware that can determine the presence or absence of consumable content and provide sensory feedback when consumable content has been progressively or substantially consumed.

For example, an item of tableware (e.g., plate, cup, mug, dish, bowl, etc.) with photosensors may undergo an ambient light calibration through sensors at the edges of the tableware to establish an uncovered state. When consumable content (e.g., food, liquids, etc.) is placed on the tableware, it covers one or more sensors on the eating surface, which reduces the light they detect by the photo sensors. This may establish a covered state. As a user consumes the consumable content, one or more sensors become uncovered. When a state change is detected, a sensory response is triggered such as, for example, LEDs or speakers are activated.

As another example, by distributing a plurality of photosensors throughout the tableware, progressive feedback can be provided. For example, when a first photosensor is uncovered, a first LED (or subset of LEDs) may be activated. When a second photosensor is uncovered, a second LED (or second subset of LEDs) may be activated. When a third photosensor is uncovered, a third LED (or third subset of LEDs) may be activated. As additional photosensors are uncovered, additional LEDs may be activated.

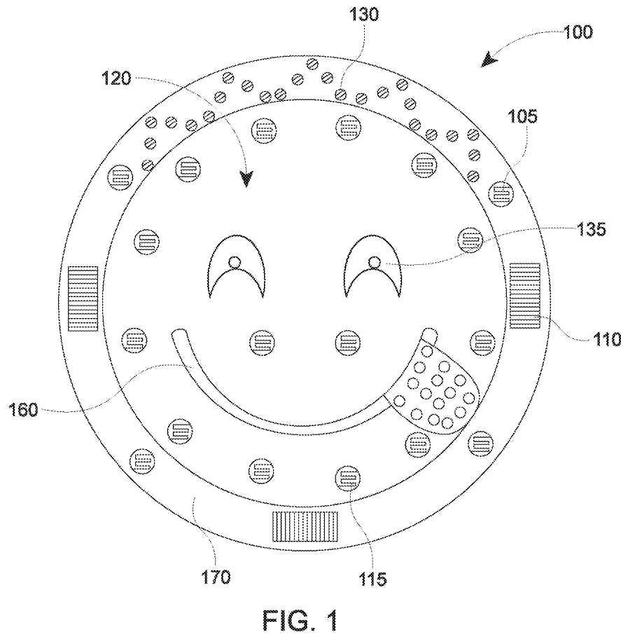

FIG. 1 is an illustration of top of a plate 100. And FIG. 2 is an illustration of the side of the plate 100. The plate 100, for example, may be any type of plate that is commonly used for eating. The plate 100 includes a central flat portion 160 and a rim 170. The rim 170, for example, may include a raised portion of the plate 100 that is raised relative to the central flat portion 160. The rim 170, for example, may include an edge of the plate 100. The rim 170, for example, may include an outer portion of the plate 100 that is not raised relative to the central flat portion 160. The rim 170, for example, may include an outer portion of the plate 100.

The plate 100, for example, may be constructed from a food-safe material such as polypropylene, silicone, BPA-free plastic, or tempered glass.

The plate 100 may include one or more rim sensors 105 disposed on and/or around the rim 170. The plate 100 may include one or more central sensors 115 disposed on and/or within the central flat portion 160. The one or more rim sensors 105 and/or the one or more central sensors 115, for example, may include any type of sensor that detects light. The one or more rim sensors 105 and/or the one or more central sensors 115, for example, may include photoresistors, photodiodes, light-dependent resistors, phototransistors, capacitive sensors, weight sensor, pressure sensor, etc.

Alternatively or additionally, the plate 100 may include one or more solar cells 110 disposed on and/or around the rim 170. The plate 100 may not include these one or more solar cells 110. The one or more solar cells 110, for example, may charge a battery disposed within the body of the plate 100.

The central flat portion 160, for example, may include a graphic 120. The graphic may have any type of design. The graphic, for example, may or may not be backlit via a plurality of LEDs. As another example, the graphic 120, for example, may include a plurality of LEDs arranged in any configuration or design. The graphic 120 may include an LCD, LED, OLED, QLED, QD-OLED, mini-OLED, etc. display.

As another example, the graphic 120 and either or both the one or more rim sensors 105 and/or the one or more central sensors 115 may be combined in a touchscreen display that provides both state information regarding items such as food touching the touchscreen display and feedback in response to a change in the state by displaying different images or videos on the touchscreen. The plate 100 may include one or more rim LEDs 130 disposed on and/or around the rim 170. The plate 100 may include one or more central LEDs 135 disposed on and/or within the central flat portion 160. The one or more rim LEDs 130 and/or the one or more central LEDs 135 may include any device that emits light. The one or more central LEDs 135 and/or the one or more rim LEDs 130 may include LEDs of different colors and types.

The plate 100 may include a circuit board 210 disposed within the plate 100. The circuit board 210, for example, may include a microcontroller that that is electrically coupled with the one or more rim LEDs 130, one or more central LEDs 135, the one or more rim sensors 105, and/or the one or more central sensors 115. The microcontroller, for example, may be programmed with the logic to monitor sensors and/or activate responses one or more rim LEDs 130, one or more central LEDs 135, and/or speaker 180.

The microcontroller, for example, may include an integrated circuit programmed to perform the functions described in this document. The microcontroller, for example, may include a processor or controller programmed to perform the functions described in this document.

The plate 100, for example, may include a battery 215 (e.g., Lithium-Polymer) that may power the operation of the circuit board 210, the one or more rim LEDs 130, the one or more central LEDs 135, the one or more rim sensors 105, and/or the one or more central sensors 115.

The plate 100, for example, may include a speaker 180. The plate 100, for example, may include a power switch 220. The power switch 220, for example, may activate or deactivate power from the battery 215 to the circuit board 210, microcontroller, the one or more rim LEDs 130, the one or more central LEDs 135, and/or the speaker 180.

The microcontroller, for example, may control the operation of the one or more rim LEDs 130, one or more central LEDs 135, one or more rim sensors 105, and/or the one or more central sensors 115. The microcontroller, for example, may determine whether consumable content on the plate 100 have been placed and/or removed from the plate 100.

The microcontroller, for example, may detect a state change based on the presence and/or absence of consumable contents (e.g., food, liquid, etc.) on at least a portion of the plate 100. The state change may be determined based on data provided by the one or more rim sensors 105, and/or the one or more central sensors 115.

The microcontroller, for example, may calculate the difference between signals from the one or more rim sensors 105 and the one or more central sensors 115. These calculations, for example, may be based on an average signal value from the one or more rim sensors 105 and/or the one or more central sensors 115.

If the difference is greater than a threshold value, the state of the plate 100 indicates that consumable content is present on the plate 100. If the difference is less than a threshold value, the state of the plate 100 indicates that consumable content is not present on the plate 100 or that some consumable content has been removed from the plate 100.

When the microcontroller determines that the state of the plate 100 indicates that consumable content is present on the plate 100, then the microcontroller, for example, may activate only the one or more rim LEDs 130 and keep the one or more central LEDs 135 deactivated. When the microcontroller determines that the state of the plate 100 indicates that consumable content is not present on the plate 100 or that some consumable content has been removed from the plate 100, then the microcontroller, for example, may activate the one or more rim LEDs 130 and activate the one or more central LEDs 135. As consumable content is progressively removed, for example, different LEDs of the one or more central LEDs 135 may progressively be turned on or flash in progressively different patterns.

Additionally or alternatively, when the microcontroller determines that the state of the plate 100 indicates that consumable content is present on the plate 100, then the microcontroller, for example, may deactivate the speaker 180. When the microcontroller determines that the state of the plate 100 indicates that consumable content is not present on the plate 100 or that some consumable content has been removed from the plate 100, then the microcontroller, for example, may activate the speaker 180. When activated, for example, the speaker may play music saved in memory located on the circuit board 210. As consumable content is progressively removed, for example, the volume of the music may increase over time and/or the audio track played through the speaker may change.

The plate 100, for example, may include a speaker or a haptic feedback device that vibrates (e.g., an eccentric rotating mass (ERM) vibration motor).

The plate 100, for example, may be a bowl, dish, mug, cup, or the like.

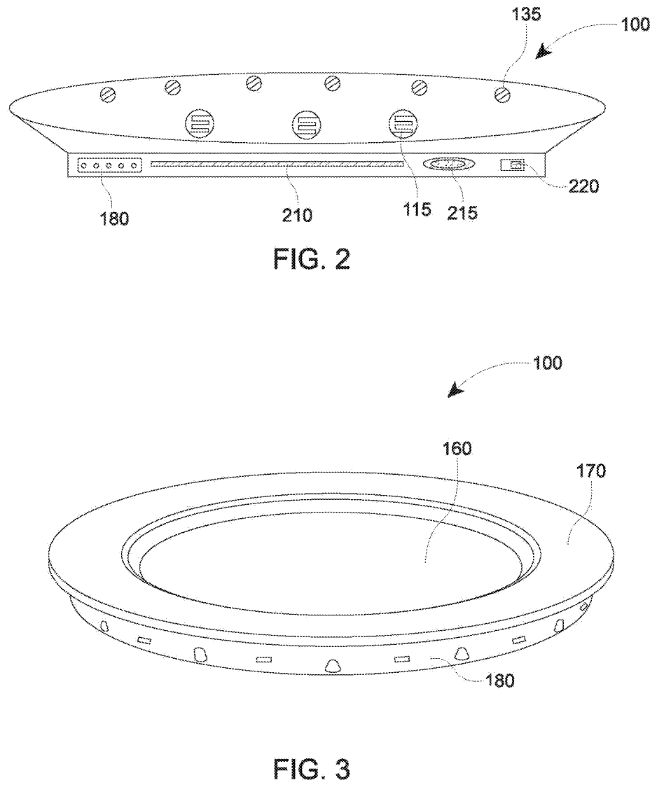

FIG. 3 is an illustration of a perspective view of the plate 100. In this example, the rim 170, for example, is raised above the central flat portion 160.

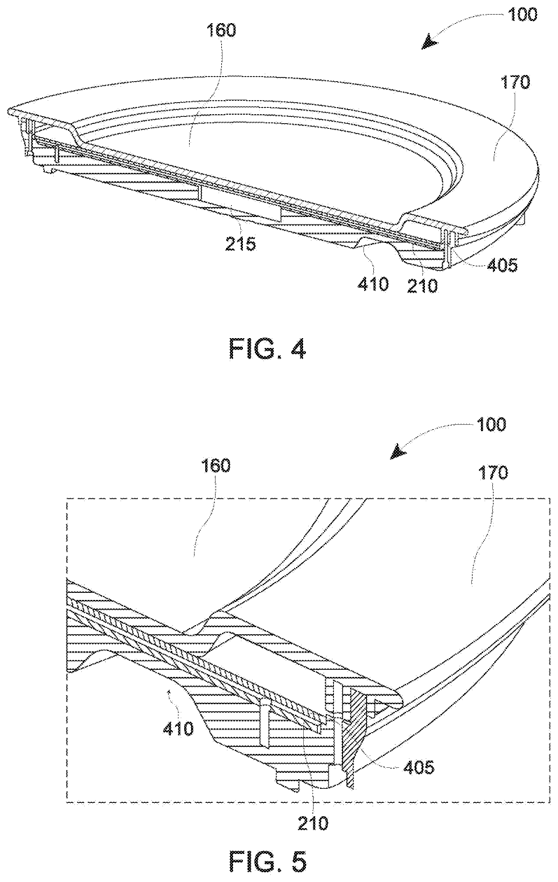

FIG. 4 is an illustration of a cutaway perspective view of the plate 100. And FIG. 5 is an illustration of a closeup cutaway perspective view of a plate 100. The central flat portion 160, for example, may be a clear layer such as, for example, of plastic material. The clear layer, for example, may include a Fresnel lens or the like. The clear layer, for example, may diffuse ambient light evenly for more reliable sensor readings and/or diffuse the light emanating from the LEDs for a more visually appealing effect.

A translucent or partially translucent graphic 405, for example, may be disposed beneath this clear layer. The translucent or partially translucent graphic 405, for example, may include any type of image. The circuit board 210 may be disposed beneath the translucent or partially translucent graphic 405. The circuit board 210, for example, may include a plurality of LEDs that when illuminated light up the translucent or partially translucent graphic 405. The circuit board 210 and translucent or partially translucent graphic 405 together may produce a backlit image that is shown through the clear layer. The plurality of LEDs on the circuit board, for example, may be controlled by the microcontroller.

The bottom of the plate 100, for example, may include an indent 410. A button or touch sensor may be disposed within the indent 410. The button or touch sensor may activate or deactivate the microcontroller. The touch sensor, for example, may be a capacitive sensor (e.g., conductivity or capacitive sensors).

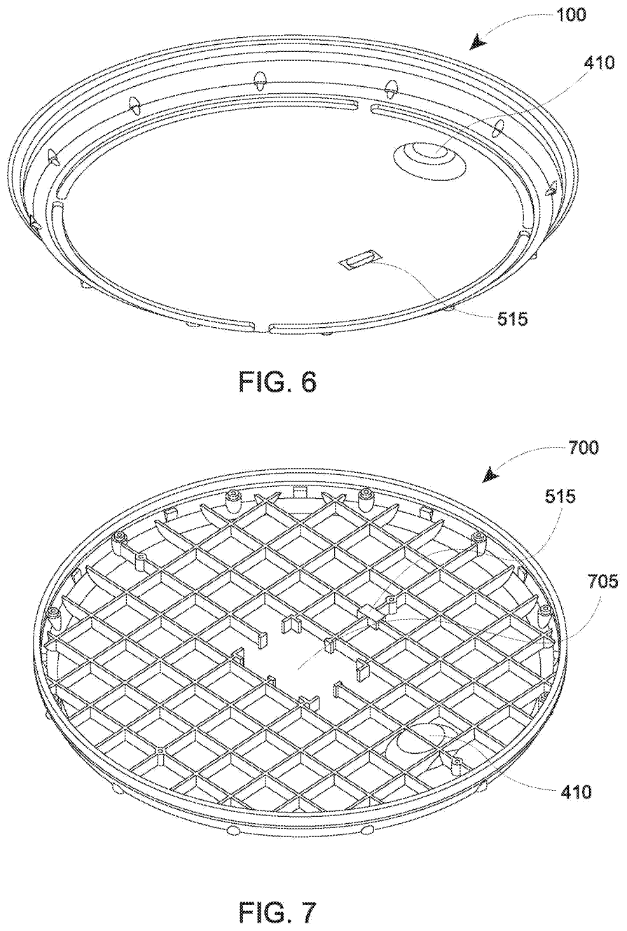

FIG. 6 is an illustration of the bottom of the plate 100. The plate 100, for example, may include a charger port 515 that can be connected with the battery 215 and may be used to charge the battery 215.

FIG. 7 is an illustration of a bottom portion 700 of a plate 100. A cavity 705 is formed within the bottom portion 700 that may be used for the battery 215. The internal portion of the charger port 515 is also shown as well as the internal portion of the indent 410.

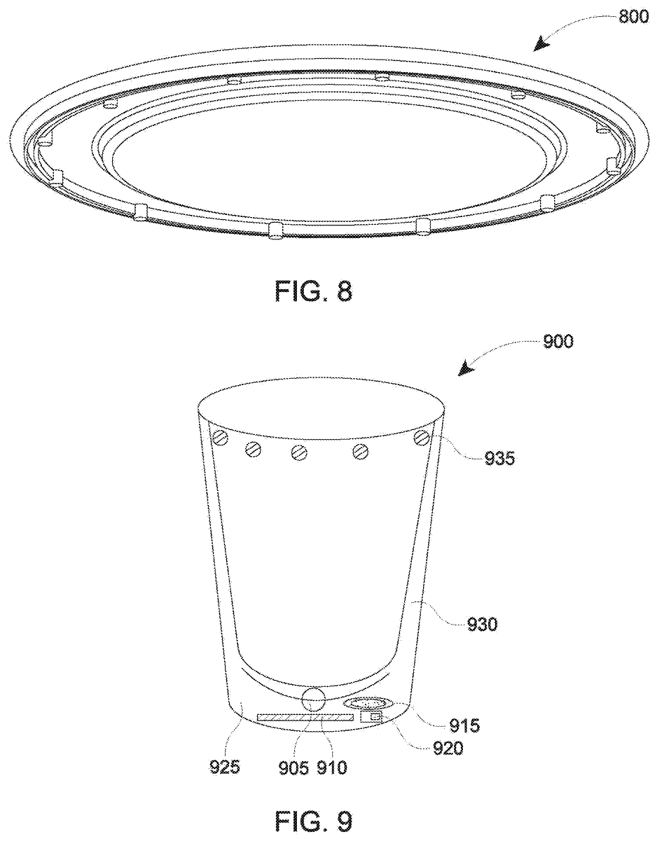

FIG. 8 is an illustration of a top portion 800 of a plate 100. The top portion 800 and bottom portion 700 may be joined together to form the plate 100.

FIG. 9 is an illustration of a side view of a cup 900. The cup 900, for example, may vertical sides 930 and bottom base 925. The cup 900, for example, includes a plurality of LEDs 935 on the rim of the cup 900 and/or along the vertical walls of cup 900. The cup 900, for example, may include plurality of capacitive sensors 905 (e.g., conductivity or capacitive sensors) disposed along the vertical sides 930 and/or in the bottom base 925. The bottom base 925 of the cup 900, for example, may include a battery 915, a circuit board 910, and/or a power switch 920. The circuit board 910, for example, may be electrically coupled with the battery 915, the power switch 920, the plurality of capacitive sensors 905, and/or the plurality of LEDs 935. The circuit board 910, for example, may include a controller or integrated circuit that controls the functions of the plurality of LEDs 935 and/or the plurality of capacitive sensors 905.

As liquid from the cup 900 is consumed, a difference in the signals from upper capacitive sensors and lower capacitive sensors of the plurality of capacitive sensors 905 may be measured and/or determined, which may signify a state change. In response to a state change, the controller may activate one or more of the plurality of LEDs 935.

The cup 900, for example, may include a speaker or a haptic feedback device that vibrates (e.g., an eccentric rotating mass (ERM) vibration motor).

The cup 900, for example, may include a speaker or a haptic feedback device that vibrates (e.g., an eccentric rotating mass (ERM) vibration motor) that may provide haptic feedback to the user in response to a state change as detected by the plurality of capacitive sensors 905 in addition to activating the plurality of LEDs 935 or instead of activating the plurality of LEDs 935.

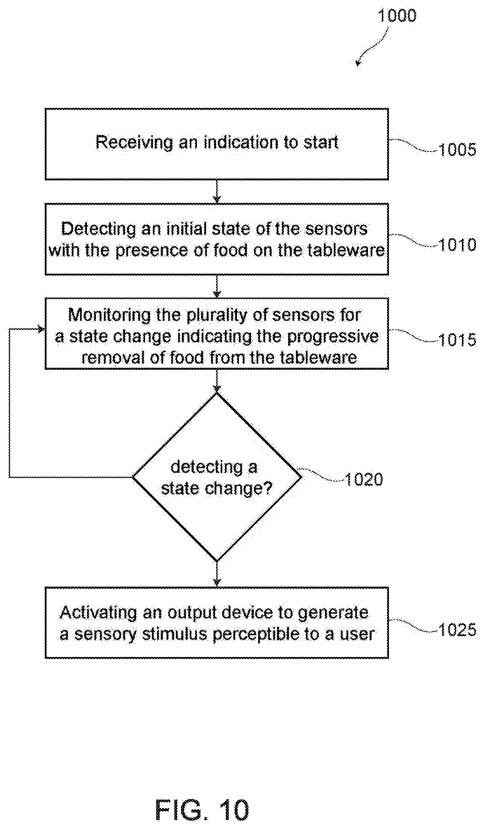

FIG. 10 is a flow chart of a process 1000 for illuminating tableware. While the process 1000 may be used with any type of tableware or dish or cup, the process 1000 is described in conjunction with plate 100. The process 1000 may begin at block 1005. At block 1005, the plate 100 may be powered on. The power switch 220, for example, may be activated to supply power from the battery 215 to the circuit board 210 and/or a microcontroller.

Following block 1005, the process may proceed to block 1010. At block 1010, the microcontroller may detect an initial state of the one or more rim sensors 105 and/or one or more central sensors 115 corresponding to the presence of food on the tableware such as, for example, plate 100. The initial state, for example, may read signals from the one or more rim sensors 105. The initial state, for example, may include an average of the signals from the one or more rim sensors 105. This may, for example, represent the ambient light level detected at the rim 170 of the tableware such as, for example, plate 100.

Following block 1010, the process may proceed to block 1015. At block 1015, the microcontroller may monitor the one or more rim sensors 105 and/or one or more central sensors 115 for a state change indicating the progressive removal of food from the tableware such as, for example, plate 100, cup 900, bowl, dish, mug, glass, cup, etc.

At block 1020, the process 1000 may determine if a state change has occurred.

A state change may be determined, for example, by determining a difference between the one or more rim sensors 105 and the one or more central sensors 115. For example, an average of the one or more rim sensors 105 may be compared with an average of the one or more central sensors 115.

As another example, a state change may occur if data from the one or more central sensors 115 is different than the initial state or any previous state of the sensors determined at block 1010, then a state change has occurred.

If a state change has not occurred, the process 1000 may return to block 1015. If a state change has occurred, the process 1000 may proceed to block 1025.

At block 1025, an output device may be activated to generate a sensory stimulus perceptible to a user. The output device, for example, may include the one or more rim LEDs 130 and/or the one or more central LEDs 135. The sensory stimulus may include light of various colors and/or various patterns. The output device, for example, may include the speaker 180 and the sensory stimulus may include music or other sounds. The output device, for example, may include a haptic feedback device that vibrates (e.g., an eccentric rotating mass (ERM) vibration motor).

Various other embodiments are also disclosed.

In certain embodiments, a bowl may include a bowl body have a convex shape, a plurality of sensors, a sensory device, and/or a microprocessor. The microprocessor may determine a state change regarding contents within the bowl based on input from the plurality of sensors and produce a sensory output via the sensory device. The plurality of sensors, for example, may include photoresistors, photodiodes, light-dependent resistors, phototransistors, capacitive sensors, weight sensors, pressure sensors, etc. The sensory device, for example, may include one or more LEDs, a haptic feedback device, a touch screen, a speaker, etc.

In certain embodiments (e.g., for adult dining or pet care), the circuit board or microcontroller may include a wireless communication module, such as a Bluetooth Low Energy (BLE) transceiver. For example, when a cup or glass may be emptied, the wireless communication module can send a signal to a central receiver at a bar or server station. This signal would discreetly alert staff that a customer may need a refill, improving service efficiency. As another example, when the food or water has been consumed in a pet bowl, the wireless communication module can send a notification to a pet owner's smartphone via a companion app. The app could also track feeding times and consumption patterns.

In certain embodiments, the one or more rim LEDs 130, one or more central LEDs 135, and/or plurality of LEDs 935 may include multi-color LEDs that can be programmed to flash, fade, or display in any combination of dynamic sequences in response to a change of state. As another example, a small, embedded OLED or LCD screen could also be activated to display graphics or encouraging messages.

In certain embodiments, a receptacle system for providing sensory feedback includes a receptacle body having a surface for holding consumable contents; a sensor array integrated within the receptacle body, configured to detect the presence and absence of said contents on the surface; at least one output device embedded within the receptacle body for producing a sensory response; and a microcontroller communicatively coupled to the sensor array and the output device, the microcontroller configured to: detect a state change in the sensor array corresponding to the progressive or complete removal of the contents from the surface; and in response to detecting said state change, activate the at least one output device to produce the sensory response.

In this embodiment, the sensor array may include a plurality of photoresistors, and the detected state change may be an increase in light level as the contents are removed.

In this embodiment, the receptacle may be a cup for holding liquid contents, the sensor array may be a capacitive sensor, and the detected state change may be a change in capacitance corresponding to the removal of the liquid.

In this embodiment, the at least one output device may be a light-emitting diode (LED) array.

In this embodiment, the microcontroller may be configured to activate the LED array in a pre-programmed sequence of colors and patterns.

In this embodiment, the at least one output device may be an audio speaker configured to play a pre-recorded sound.

This embodiment may also include a wireless communication module coupled to the microcontroller, configured to transmit a signal to a remote device upon detection of the state change.

This embodiment may also include a power source integrated within the receptacle body, wherein the power source may be selected from the group consisting of a battery and a solar cell.

In this embodiment, the power source may be triggered by the user touching a capacitive sensor

In this embodiment, the receptacle may be a child's tableware item, and the sensory response may be a positive stimulus to encourage consumption of the contents.

In this embodiment, the at least one output device may be a haptic motor configured to produce a tactile vibration.

In this embodiment, the at least one output device may be an embedded display screen configured to show a graphical image.

In this embodiment, the power source may be a rechargeable battery further comprising a charging port integrated into the receptacle body.

In this embodiment, the receptacle body may be constructed from a food-safe polymer or silicone.

In this embodiment, the microcontroller may be further configured to modify the sensory response in accordance with the number of sensors in the sensor array that have detected the removal of contents.

In this embodiment, the receptacle may be an adult beverage glass, and the sensory response may be a signal to indicate all or portions of the beverage has been consumed.

The system of claim 1, wherein the receptacle may be a pet feeding container, and the sensory response may be an alert indicating all or portions of the contents have been consumed.

This embodiment may also include a light-diffusing layer positioned over the surface to enhance the appearance of light-based responses and to normalize ambient light detection for the photoresistors.

Another embodiment may be a method for encouraging consumption of contents from tableware. The method may include detecting, via a sensor array embedded in the tableware, an initial state corresponding to the presence of consumable contents; continuously monitoring the sensor array for a state change indicating the progressive removal of said contents; and upon detecting the state change, activating an output device integrated within the tableware to generate a sensory stimulus perceptible to a user.

In this embodiment, the method may further include an initial step of calibrating a baseline ambient light level for the sensor array prior to the placement of the consumable contents.

In this embodiment, a baseline ambient light level for the sensor array may be set by sensors in the rim of the receptacle creating a reference signal and the sensors in the eating surface or area containing the consumable contents create a signal. The comparison by the MCU between the reference and the signal trigger the perceptible response.

In this embodiment, the method may further include the step of transmitting a wireless signal to a remote device upon detection of the state change.

In another embodiment, a piece of tableware includes: (a) one or more integrated light-emitting diodes (LEDs); (b) one or more graphic elements embedded, printed, or otherwise affixed to the tableware; and (c) one or more LEDs arranged to form a graphic element or composition, wherein the LEDs are arranged and configured to illuminate in coordination with the graphic elements so as to create a visual effect, such that the LEDs (i) form part of an image, (ii) enhance or animate a graphic element, (iii) interact with the graphic to convey a perceptible message or feedback to the user, or (iv) are themselves arranged to form a graphic element or composition.

A tableware, plate, cup, bowl, mug, cup, or glass is interchangeable with any other tableware, plate, cup, bowl, mug, cup, or glass. That is, for example, any use of one of these terms is applicable to the other terms without restriction.

The arrangement of various sensors, LEDs, graphics, sensory devices, and/or circuitry is not limited to the examples shown and may vary in number, type, and placement.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art.

That which is claimed:

1. A plate comprising:
a plate body comprising:
a central flat portion; and
a rim surrounding the central flat portion;
a first photosensor disposed within the central flat portion, the first photosensor producing a first signal representative of ambient light incident on the first photosensor;
a second photosensor disposed within the rim, the second photosensor producing a second signal representative of the ambient light incident on the second photosensor; and
a light emitting diode disposed within the central flat portion, wherein the light emitting diode is activated when a difference between the first signal and the second signal is below a threshold, and the light emitting diode is deactivated when a difference between the first signal and the second signal is above the threshold.

2. The plate according to claim 1, further comprising:
a translucent or partially translucent graphic disposed within the plate body; and
a light disposed below the translucent or partially translucent graphic or integrated within the translucent or partially translucent graphic that illuminates the translucent or partially translucent graphic.

3. The plate according to claim 1, further comprising a controller electrically coupled with the first photosensor, the second photosensor, and the light emitting diode, the controller configured to determine the difference between the first signal and the second signal, the controller configured to activate and deactivate the light emitting diode.

4. The plate according to claim 1, wherein the first photosensor comprises a photoresistor and the second photosensor comprises a photoresistor.

5. The plate according to claim 1, wherein the light emitting diode comprises a plurality of light emitting diodes; wherein when the plurality of light emitting diodes are activated, the plurality of light emitting diodes produces a pre-programmed sequence of colors and/or patterns.

6. The plate according to claim 1, further comprising:
a battery electrically coupled with the light emitting diode;
an indentation on a bottom surface of the plate ; and
a touch sensor disposed within the indentation and configured to open or close a circuit between the battery and the light emitting diode.

7. Tableware that provides sensory feedback, the tableware comprising:
a tableware body having a surface for holding consumable contents;
a plurality of sensors integrated within the tableware body, the plurality of sensors detect a presence and/or absence of the consumable contents on at least a portion of the tableware body;
at least one sensory output device embedded within the tableware body that produces a sensory output; and
a microcontroller disposed within the tableware body, the microcontroller communicatively coupled to the plurality of sensors and the at least one sensory output device, the microcontroller configured to:
detect a state change in the plurality of sensors corresponding to a progressive or complete removal of consumable contents from the surface of the tableware body; and
in response to detecting the state change, activate the at least one sensory output device to produce the sensory output.

88. The tableware according to claim 7, wherein the plurality of sensors comprises a plurality of photo resistive sensors and the state change is a change in light detected by the plurality of photo resistive sensors in response to the progressive or complete removal of consumable contents.

9. The tableware according to claim 7, wherein the plurality of sensors comprises a plurality of capacitive sensors and the state change is a change in the capacitance detected by at least one of the plurality of capacitive sensors in response to the progressive or complete removal of consumable contents.

10. The tableware according to claim 7, wherein the output device comprises one or more light emitting diodes.

11. The tableware according to claim 7, wherein the output device comprises a speaker.

12. The tableware according to claim 7, further comprising:
a translucent or partially translucent graphic disposed within the tableware body; and
a light disposed below or within the translucent or partially translucent graphic that illuminates the translucent or partially translucent graphic.

13. The tableware according to claim 7, wherein the state change is a difference measured by the microcontroller between two sensors of the plurality of sensors.

14. The tableware according to claim 13, wherein a first sensor of the two sensors is disposed in a central portion of the tableware body and a second sensor of the two sensors is disposed in an outer rim of the tableware body.

15. A method comprising:
detecting, via one or more of a plurality of sensors embedded in a tableware, an initial state corresponding to the presence of food on the tableware;
continuously monitoring the plurality of sensors for a state change indicating progressive removal of food from the tableware; and
upon detecting the state change, activating an output device integrated within the tableware to generate a sensory stimulus perceptible to a user.

16. The method according to claim 15, wherein the sensory stimulus comprises emitting light.

17. The method according to claim 15, further comprising illuminating a light within the tableware from a light source disposed below or within a translucent or partially translucent graphic.

18. The method according to claim 15, wherein the state change is a difference measured by a microcontroller between two sensors of the plurality of sensors.

19. The method according to claim 18, wherein a first sensor of the two sensors is disposed in a central portion of the tableware and a second sensor of the two sensors is disposed in an outer rim of the tableware.

20. The method according to claim 15, wherein the plurality of sensors comprises a plurality of photosensors.
